(19) United States
(12) Patent Application Publication
(10) Pub. No.: US 2001/0036427 A1
(43) Pub. Date: Nov. 1, 2001

(54) Cell structure mounting container and assembly thereof

(75) Inventors: Toshio Yamada, Nagoya-city (JP); Toshihiko Hijikata, Nagoya-city (JP); Yukihito Ichikawa, Nagoya-city (JP)

Correspondence Address: PARKHURST & WENDEL, L.L.P., Suite 210, 1421 Prince Street, Alexandria, VA, 22314-2805, US

(73) Assignee: NGK INSULATORS, LTD.

(21) Appl. No.: 09/799,054

(22) Filed: Mar. 6, 2001

(30) Foreign Application Priority Data
Mar. 31, 2000 (JP) 2000-098817

(51) Int. Cl. B01D 53/88; B01D 53/94; B01D 53/34; F01N 3/28

(52) U.S. Cl. 422/179; 422/177; 422/180

(57) ABSTRACT

A cell structure mounting container comprises a cell structure stored within a metal container. The cell structure is held within the metal container by providing a compressed resilience material having cushioning characteristics between the cell structure and the metal container in a compressed state. The compressed resilience material is a heat-resistant and low-expansion material containing ceramic fibers or ceramic fibers and heat-resistant metal fibers. Accordingly, compression characteristics which do not greatly fluctuate within the usage temperature range are obtained, the compression force acting on the periphery portion of the cell structure does not change greatly, and further, the compression force acts essentially uniformly on the periphery portion of the cell structure.

Thus, a cell structure mounting container and an assembly thereof can be provided wherein there is little change in compressive pressure on the cell structure within the metal container within the usage temperature range of the catalytic converter or the like, and the compressive pressure distribution is uniform, thereby preventing damage to the cell structure.

### BACKGROUND OF THE INVENTION

1. Field of the Invention

The present invention relates to a cell structure mounting container and an assembly thereof, which can be applied to purification exhaust gasses from internal combustion engines, deodorizing catalyst carrying members or filters, or chemical reaction devices which use catalytic effects such as catalyst carrying members or filters used with fuel cell reformers.

2. Description of the Related Art

In accordance with recently tightened exhaust gas restrictions, improvements have been made to reduce the amount of harmful matter discharged from engines themselves, such as hydrocarbons (HC), carbon monoxide (CO), oxides of nitrogen (NOx), and so forth, and on the other hand, improvements have been made with three way catalyst which currently is mainstream, thereby reducing the amount of discharged harmful matter from both sides.

However, as improvements have proceeded along with such tightened exhaust gas restrictions, overall exhaust while the engine is running has been reduced, and now the amount of harmful matter discharged at the time immediately following starting the engine has become the center of focus. For example, 60% to 80% of the total amount of emission is discharged within the Bag-1 mode which is the first 140 seconds after starting the engine according to the FTP-75 cycle (Federal Test Procedure Cycle) which is the restriction driving cycle in the USA,. This is because immediately following starting the engine (Bag-1A) the exhaust gas temperature is low and the catalyst is not activated sufficiently, so the harmful matter passes through the catalyst without being purified.

Also, another cause is that the combustion state is not stable in engines immediately after starting, and the air/fuel ratio (A/F), i.e., the ratio of oxygen in the exhaust gas, which is an important factor that affects the purification capabilities of the three way catalyst, changes. The catalyst manifest the purification capabilities thereof most efficiently at a theoretical air/fuel ratio of A/F 14.7. As for the catalyst, generally-used arrangements involve the ceramic honeycomb structure of which cell partition surfaces being loaded with γ alumina having a finely porous structure and great area; said γ alumina being loaded with a precious metal component such as platinum, palladium, rhodium, and so forth as a catalytic component.

Accordingly, various attempts are being made to speedily raise the temperature of the catalyst immediately after starting the engine, such as placing the catalyst where the temperature of the exhaust gas is high by positioning the catalyst as close to the engine as possible, making the cell partitions thin to lower the thermal capacity of the catalyst itself, increasing the cell concentration of the carrying member in order to increase the amount of area of contact between the catalyst and exhaust gas while speedily absorbing the heat of the exhaust gas, and so forth.

As for the engine, improvements are being made in order to allow the A/F to reach the theoretical air/fuel ratio as fast as possible. Also, regarding the catalyst, ceria and zirconia and the like are added along with the precious metal components such as platinum, rhodium, palladium, and so forth which act as catalysts, thereby mounting and stripping the exhaust gas of oxygen, in order to damper the A/F fluctuations as much as possible. These precious metals and oxygen storing materials are dispersed in micro-pores of γ-alumina layer loaded at the surfaces of the porous cell partitions (ribs) of the carrying member.

As for the honeycomb structure for the catalyst, cordierite material which is a highly heat resistant and low heat expanding ceramic is primarily used, and square-shaped cells are generally used for the automobile exhaust gas purification catalyst carrying member with regard to the cell structure of the honeycomb structure. However, there are also other cell shapes, such as rectangles, triangles, hexagons, circles, and so forth. Further, there is a metal honeycomb structure wherein rippled heat-resistant stainless steel foil is combined with plates and wound in a corrugated fashion. In this case, the cell shape is in the form of a sine waveform.

The cell partition thickness of the automobile exhaust gas purification catalyst carrying member is primarily around 0.11 mm to 0.17 mm and the cell density is from 300 to 1,200 cpsi, but there are also arrangement wherein the partitions are even thinner; around 0.02 mm to 0.1 mm. There are also high cell density configurations for use with heat exchangers with 1,200 cpsi or higher. The cell structure is defined by cell partition thickness and cell density. The cell destiny is normally represented in cpsi, which is short for “cells per square inch”, meaning that 400 cells in one square inch would be represented as cell density of 400 cpsi. The cell partition thickness is also called rib thickness, and conventionally has been represented in increments of mil. One mil is 1/1,000 inch, and is approximately 0.025 mm.

Conventionally, arrangements are employed wherein a heat expanding material mat containing vermiculite is used to hold the cell structure for caning in the metal container (see U.S. Pat. Nos. 5,207,989 and 5,385,873), but in this case, the compressive pressure rapidly increases due to the heating expansion, and on the other hand cell structures of thin-partition honeycomb structures or the like have little structural strength, so in the event that compressive pressure exceeds the structural strength (isostatic strength), as readily occurs, the probability of the cell structure being destroyed is high. Also, the compression characteristics of the heat expansion mat rapidly begin to deteriorate from around 800° C., so compressive pressure is lost at around 1,000° C., and the heat expansion mat is no longer capable of holding the cell structure. Conversely, in the event of using a non-intumescent material mat which does not contain vermiculite (see U.S. Pat. No. 5,580,532 and Japanese Patent No. 2,798,871), change in compressive pressure accompanying the increase in temperature is extremely small, and compressive pressure hardly decreases at all even at 1,000° C., so the cell structure can be held.

FIG. 12 shows the results of an experiment performed wherein both types of mats were held between two flat plates, pressurized by a load cell, and in this state, while being heated in an electric furnace, the change in compressive pressure was measured. A sample is cut into a 50×50 mm size, sandwiched between two silica glass plates, and set in a testing device provided with an electric furnace. With the sample standing at room temperature, a pressure of 2 kg/cm² is applied by load cell. The electric furnace is heated, and the compressive pressure is measured at the point that the atmospheric temperature within the furnace reaches 100° C., and from then on every 100° C. up to 1,000° C. The expansion mat is a commercially-available mat containing vermiculite, and the non-expanding mat is a commercially-available alumina fiber type non-intumescents mat (product name: “MAFTEC”). Even with non-heat expanding mats, in the event that the fiber material is alumina silicate, the compressive pressure decreased from around 800° C. and there was hardly any compressive pressure remaining at 1,000° C., though the increase in compressive pressure was not as rapid as with expanding mats.

Conventionally, holding of the cell structure such as the honeycomb structure with thin partitions was performed by using non-expanding holding material instead of the heat expanding holding material, but in the event that canning in the metal container is performed following wrapping the mat which is the holding material around the cell structure, positional shifting readily occurs at the matching part of the mat, which tends to result in high compressive pressure. Also, at the time of pressing in the cell structure with the mat wrapped thereon into the metal container, the mat shifts in the pressing direction, and tends to wrinkle, so compressive pressure tends to be high at such portions as well. Thus, the compressive pressure distribution acting on the outer periphery portion of the cell structure becomes non-uniform. The cell structure is destroyed in the event that the partially increased compressive pressure exceeds the isostatic strength of the cell structure. Also, the compressive pressure distribution is not uniform, so the cell structure readily shifts due to engine vibrations during use, exhaust gas pressure, and so forth.

The cell structure strength is measured by the “isostatic destructive strength test”. This is a test performed by placing the carrier which is the cell structure within a rubber cylindrical container, closing an aluminum plate lid, and placing isotropic pressure thereupon underwater. This is a test for reproducing the compression load weight of the carrier being held by the outer periphery portion of the converter can. The isostatic strength is represented by the value of the pressure being applied at the instant that the carrier is destroyed, and is stipulated in JASO Stipulation M505-87 of the automobile stipulations issued by the Society of Automotive Engineers of Japan, Inc. Usually, a canning structure which takes advantage of external periphery holding of the carrier is used for automobile exhaust gas purification catalytic converters. Of course, the higher the isostatic strength of the carrier is, the better, from the perspective of canning.

Generally, ceramic honeycomb-shaped structures are used for automobile exhaust gas purification catalytic converters, and it has been discovered that in the event that the cell partition thickness is 0.1 mm or less and the opening percentage exceeds 85%, it is extremely difficult to maintain the isostatic strength at 10 kg/cm² or higher.

FIG. 13 shows an example of results obtained by a test performed wherein a pressure-sensitive sheet employing electric contact resistance is introduced between a cordierite ceramic honeycomb structure (106 mm in diameter×150 mm, with a cell structure of 2.5 mil/900 cpsi) and a holding material mat, measuring the compressive pressure at the time of canning by pressing the above into a stainless container (material 409, plate thickness 1.5 mm) or canning by wrapping, and comparing this with the calculated design compressive pressure. With either canning method, the actually-measured maximum compressive pressure valued occurs at the matching part of the mat, exhibiting a value higher than the average compressive pressure. Particularly, with the press-in canning method, the compressive pressure was overall greater at the first half of the mat pressing side as compared to the latter half. Tests were also performing with the swaging method and roll forging method, obtaining results similar to those of the wrapping method. A commercially-available alumina fiber type non-heat expanding mat was used for the mat. The design compressive pressure was calculated from the gap dimensions obtained by subtracting the design values for the external diameter of the carrier from the design values for the internal diameter of the container, and mat bulk density specified in the specification thereof. With either of pressing in or wrapping, the actually measured average values for compressive pressure were almost the same as the design compressive pressure, but the actually measured maximum values for compressive pressure were far higher than the average compressive pressure, markedly protruding. The reasons are change in gap and wrinkling at the mating face of the mat due to the margin of precision of the outer diameter of the actual honeycomb structure, and shifting of the mat, these being also affected by the flexibility of the mat material. With pressing in, the higher the design compressive pressure is the greater the difference between maximum compressive pressure and average compressive pressure tends to be, indicating that the effects of the mat shifting at the time of inserting into the can are great. The tendency for the maximum compressive pressure to saturate is observed at the maximum compressive pressure side for pressing in, but this is due to the ceramic fibers breaking under the high compressive pressure and the resilience thereof deteriorating. Accordingly, applying excessive compressive pressure leads to breaking of the ceramic fibers, and is undesirable.

In cases wherein the isostatic strength of the honeycomb structure is exceeded in the event that compressive pressure greater than the actual design compressive pressure designed for the canning is generating in a certain location at the time of actually canning, there is the danger of the structure being destroyed at that location. As the cell partition thickness of the honeycomb structure becomes thinner, and the structural strength level decreases, there is the need to lower the design compressive pressure, but this must be carried out by suppressing abnormal increase in compressive pressure during the actual canning, and keeping changes in compressive pressure as small as possible. A situation wherein the design compressive pressure and the actual compressive pressure is the same enables the canning design aimed for, and is ideal.

Further, there is the possibility that the honeycomb structure may be destroyed by locally great holding compressive pressure since the compressing pressure acting on the outer periphery portion or the honeycomb structure is not uniform, due to the gap between the honeycomb structure and the metal container not being constant owing to the outer form precision of the honeycomb structure, and the shifting of the holding material at the time of mounting the honeycomb structure within the metal container. The thinner the partition wall thickness of the honeycomb structure becomes, the lower the isostatic strength level of the honeycomb structure is, so there is the need to lower the compressive pressure for holding the honeycomb structure while maintaining the minimally necessary compressive pressure for holding the honeycomb structure, and there is the need to reduce the irregularities in compressive pressure as the compressive pressure level becomes lower, i.e., to realize an even more uniform compressive pressure distribution.

FIG. 14 shows the relation between the design compressive pressure at the maximum gap position and minimum gap position, and the actually measure canning compressive pressure, according to tests made to find the effects of the amount of deformation of the outer diameter of the structure on the canning compressive pressure, wherein a commercially-available alumina fiber type non-heating expansion mat (plane density of 1,200 g/m²) was wrapped onto a solid aluminum cylinder which had been intentionally deformed by eccentric working of the outer diameter (actually-measured average diameter 103 mm, maximum diameter 104.3 mm, minimum diameter 102.3 mm, length 120 mm), and performing press-in canning of the above article into a stainless steel container (inner diameter 110.9 mm, working tolerance±0.3 mm). It can be understood that the gap greatly changes owing to the outer diameter precision of the structure, and the compressive pressure also changes according to this. Here as well, the compressive pressure was at a high value of 4.5 kg/cm² at the mat mating face.

### SUMMARY OF THE INVENTION

Thus, the present invention has been made in light of the above-described conventional problems, and accordingly, it is an object thereof to provide a cell structure mounting container and an assemble thereof wherein, in the actual usage temperature range of a catalytic converter and the like, change in compressive pressure on the cell structure within the metal container is small, and the compressive pressure distribution is uniform, thereby preventing destruction of the cell structure.

That is, according to the present invention, a cell structure mounting container mounting a cell structure within a metal container is provided, wherein the cell structure is held within the metal container by providing a compressed resilient material having heat-resistance and cushioning characteristics between the outer periphery portion of the cell structure and the metal container, in a compressed state, and wherein the compressed resilient material having heat-resistance and cushioning characteristics is a heat-resistant low thermal expansion material containing either ceramic fiber or ceramic fiber and heat-resistant metal fiber, having compression characteristics which do not greatly fluctuate within a usage temperature range, with the compression force acting upon the periphery portion of the cell structure not changing greatly, and further acting essentially uniformly upon the entire periphery portion of the cell structure.

With the present invention, the compressed resilient material is preferably provided between the periphery portion of the cell structure and the metal container in without having a mating face such as with a mat or blanket. Also, this cell structure mounting container is suitably used for purification automobile exhaust gasses.

Also, according to the present invention, the compressed resilient material having heat-resistance and cushioning characteristics preferably is a non-intumescent material essentially not containing vermiculite or a heat expansion material containing small amounts of vermiculite; said material comprising a ceramic fiber containing as a primary component thereof at least one member selected from the group consisting of alumina, high alumina, mullite, silicon carbide, silicon nitride, zirconia, and titania or a compound of those materials.

Also, in the case of the present invention, said ceramic honeycomb mounting container is preferably produced by covering the periphery portion of a cell structure beforehand with the compressed resilient material, incasing the resultant cell structure in a metal container in such manner that a compressive pressure is applied to the cell structure, thereby holding the cell structure within the metal container. Also, the means for mounting the cell structure within the metal container and applying compressive pressure to the cell structure via the compressed resilient material preferably is one of clamshell, stuffing, tornqiuet, swaging, or roll forging.

Further, the cell structure is held within the metal container, preferably by filling the gap between the metal container and the cell structure with the compressed resilient material following positioning the cell structure within the space in the metal container, and applying external pressure from the outer side of the metal container. As to the metal container usable for the present invention, any type of metal containers may be used as far as such a metal container can store the cell structure by virtue of any one of the above-mentioned mounting methods for the cell structure under application of compressive pressure thereto. For example, a can type container, swaging type, roll forging type, or the like may be given as a non-limitative example.

According to the present invention, the compressed resilient material preferably is filled in the state of the cell structure at a low temperature being positioned within the metal container at a high temperature, following which the entire article is cooled to room temperature, thereby applying compressive pressure to the cell structure, and also preferably the compressed resilient material and heat-resistant metal wire mesh are introduced between the cell structure and the metal container in a mixed state while applying compressive pressure to the cell structure.

Further, the wire mesh is preferably positioned on the periphery portion of the cell structure beforehand, with the compressed resilient material being applied from the periphery portion so as to fill in the wire mesh entirely. Also, the cell structure and the wire mesh are preferably placed within the metal container beforehand such that the wire mesh is introduced between the metal container and the cell structure, and the compressed resilient material is filled in between the metal container and the cell structure.

As for the cell structure used with the present invention, the cell structure is preferably a ceramic honeycomb structure having a plurality of cell channels formed of a plurality of partitions, wherein the cell partitions are 0.1 mm or less in thickness, and the percentage of opening is 85% or more. Also, an outer wall forming an outer circumference outline for the cell structure is preferably formed at the periphery portion of the ceramic honeycomb structure, wherein the thickness of the outer wall is at least 0.05 mm. Further, the periphery plane of the cell structure outer wall is preferably covered with a heat-resistant low thermal expansion material which essentially does not have compression resilience.

Also, the ceramic honeycomb structure preferably comprises a main body which does not have an outer wall and has the cell partitions exposed to the outer periphery portion of the honeycomb structure, and a shell part of heat-resistant material containing ceramic fiber positioned at the periphery portion of the main body so as to also exist between exposed cell partitions. In this case, the heat-resistant material layer containing the ceramic fiber at the shell portion preferably has compression resilience, thereby manifesting compressive pressure for holding the honeycomb structure within the metal container.

As for the cell structure used with the present invention, the cell structure may be a foam structure formed of a ceramic material or a heat-resistant metal material, instead of the ceramic honeycomb structure. Also, the cell structure preferably comprises one heat-resistant material selected from the group of cordierite, alumina, mullite, zirconia, zirconium phosphate, aluminum titanate, silicon carbide, silicone nitride, titania, stainless steel materials, nickel materials, and the like or any compound of them.

According to the present invention, the cell structure is preferably stored in and held within the metal container after loading the cell structure with a catalyst component, in the event of using the cell structure mounting container as a catalytic converter. Also, loading a catalyst component by the cell structure following mounting and holding the cell structure in and by the metal container is also preferable.

Also, according to the present invention, a cell structure mounting container assembly is provided, comprising a plurality of the cell structure mounting containers holding the cell structures and arrayed serially along the direction of fluid flow within a single metal outer cylinder, wherein, of the plurality of cell structure mounting containers, at least the cell structure mounting containers at the front side and the rear side are fixed to the metal outer cylinder by laser beam welding from the outer periphery portion of the metal outer cylinder.

### BRIEF DESCRIPTION OF THE DRAWINGS

FIG. 1 is a partially cutaway explanatory diagram illustrating an example of pressing a cell structure into a metal container;

FIG. 2 is a perspective view illustrating an example of the tornqiuet method for mounting a cell structure within a metal container;

FIG. 3 is a perspective view illustrating an example of the clamshell method for mounting a cell structure within a metal container;

FIG. 4 is a cross-sectional view illustrating an example of the swaging method for mounting a cell structure within a metal container;

FIG. 5 is another cross-sectional view illustrating an example of the swaging method for mounting a cell structure within a metal container;

FIG. 6 is a partial cross-sectional view illustrating an example of mounting the cell structure into the metal container in the state of wire mesh mixed into the compressed resilient material;

FIG. 7A is a plan view illustrating an example of a honeycomb structure with an outer wall formed at the periphery portion thereof;

FIG. 7B is a perspective view of the arrangement shown in FIG. 7A;

FIG. 8 is a partially enlarged cross-sectional diagram illustrating an example of providing a periphery portion coat portion to the periphery portion of the honeycomb structure;

FIG. 9 is a cross-sectional diagram illustrating an example of the cell structure mounting container assembly according to the present invention;

FIG. 10 is an explanatory diagram illustrating various examples of cell shapes;

FIG. 11 is a graph illustrating the canning compressive pressure and maximum/minimum change states of the first through fourth embodiments and first comparative example;

FIG. 12 is a graph illustrating the state of change of compressive pressure as to the temperature of expanding mats and non-expanding mats;

FIG. 13 is a graph illustrating the relation between canning design compressive pressure and actual compressive pressure; and

FIG. 14 is a graph illustrating the relation between the design compressive pressure and actual compressive pressure at the maximum gap and minimum gap positions.

### DETAILED DESCRIPTION OF THE PREFERRED EMBODIMENTS

The following is a detailed description of the present invention based on embodiments thereof. It should be noted however, that the present invention is by no means restricted by these embodiments.

The present invention relates to a cell structure mounting container with a cell structure stored inside a metal container, which involves holding the cell structure within the metal container by introducing a compressed resilient material having heat-resistance and cushioning characteristics in a compressed state between the periphery portion of the cell structure and the inner face of the metal container. Also, with the present invention, the compressed resilient material having heat-resistance and cushioning characteristics which is used is a heat-resistant low thermal expansion material containing either ceramic fiber or ceramic fiber and heat-resistant metal fiber, having compression characteristics which do not greatly fluctuate within a usage temperature range, with the compression force acting upon the periphery portion of the cell structure not changing greatly, and further acting essentially uniformly upon the entire periphery portion of the cell structure.

As described above, the causes of the compressive pressure greatly changing from one part to another at the time of canning and thus loosing uniformity, or the compressive pressure increasing thereby, can be organized into the following three major factors:

(1) wrinkling at the mating face of the mat at the time of bearing the compressive pressure load;

(2) shifting of the mat at the time of inserting into the metal container (can); and

(3) non-uniformity of the gap between the cell structure and the can due to outer diameter precision of the cell structure.

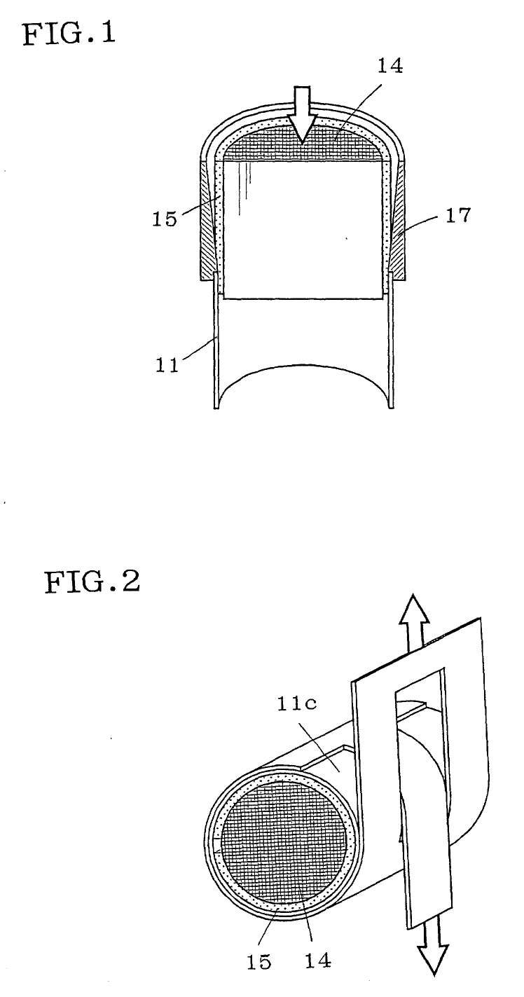

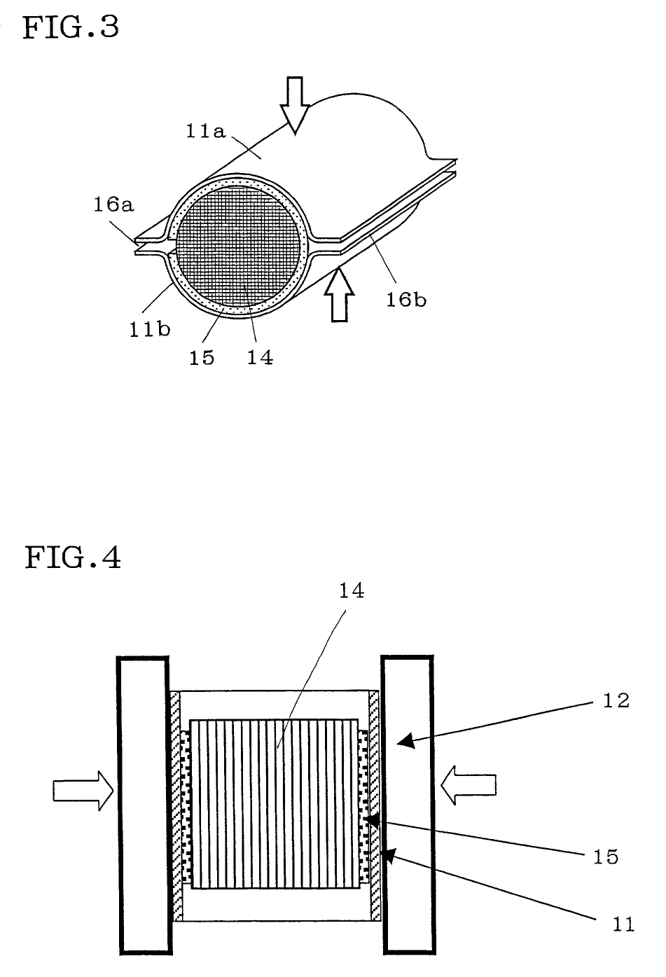

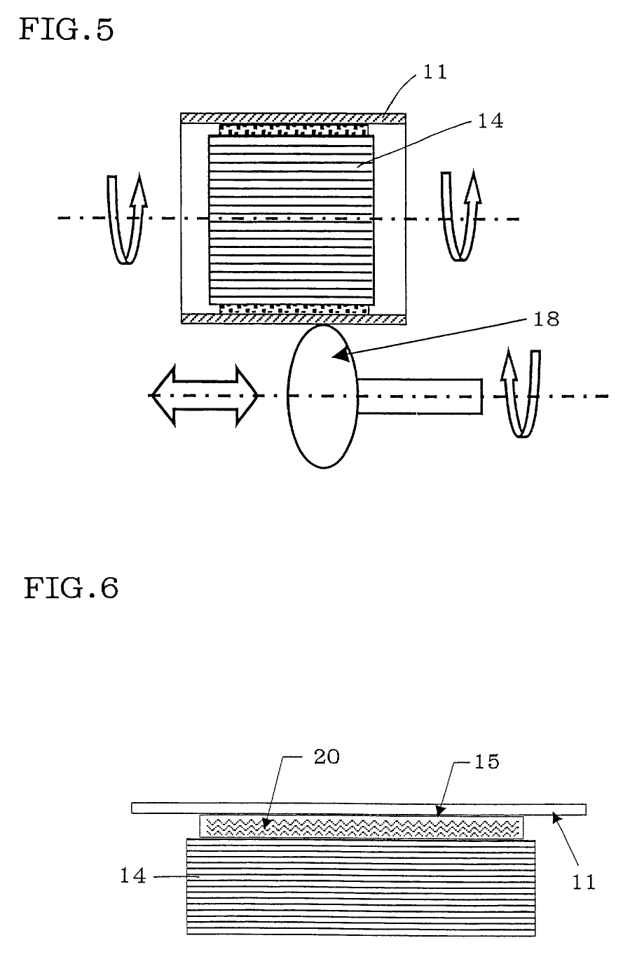

Generally, either the press-in method shown in FIG. 1, the wrapping method shown in FIG. 2, or the clamshell method shown in FIG. 3, are used as a method for canning. Also performed is a method such as shown in FIG. 4 wherein metal plasticity working technology is applied and compression pressure is externally applied to the metal container 11 by a tap (pressurizing) 12, so as to reduce the outer diameter dimensions of the metal container 11 (this method is known as the swaging method). Further, as shown in FIG. 5, a method can be used wherein metal plasticity working is applied and the outer periphery plane of the metal container 11 is reduced by metal plasticity working while rotating the metal container 11 using a jig 18, called the roll forging method, thereby reducing the outer diameter of the metal container and providing compressive pressure.

As shown in FIGS. 1 through 3, the above clamshell, press-in, and wrapping methods wind a compressed resilient holding material (a compressed resilient material) 15 onto the cell structure 14 beforehand, and with the clamshell method, as shown in FIG. 3, an integral container is formed by sandwiching the above article between metal container halves 11a and 11b while applying pressure thereof, and welding the mating faces (flanges) 16a and 16b of the two metal container halves 11a and 11b. The press-in method uses a guide 17 to insert the article into the integral container 11 under pressure, as shown in FIG. 1. The wrapping method involves applying compresive pressure by wrapping a metal plate 11c onto the article 11c and pulling, as shown in FIG. 2, following which the matching portion on the metal plate 11c is welded and fixed.

The above problem (1) of the mat wrinkling at the mating face occurs with any of the above canning methods, as long as a mat is used. This is also affected by the working precision of the matching part of the mat, and the relation between the opened length and the periphery portion dimensions of the cell structure, so keeping wrinkling at the matching part of the mat is difficult, and the compressive pressure abnormalities which occur at the mating face differ greatly from one unit to another. Accordingly, we have found that an essential solution for this problem would be not to use a mat with a mating face. Thus, according to the present invention, the step of forming a mating face may be omitted by covering in advance the periphery portion surface of the cell structure with a compressed resilient material by coating or the like, instead of using a mat.

As for the above problem (2) of mat shifting, shifting of the mat (compressed resilient material) occurs with the clam shell method at the time of pressing the metal container (can) halves 11a and 11b from above and below, and with the press-in method, shifting of the mat occurs at the insertion side for insertion into the can 11. In the event that such shifted portions are widespread, the overall compressive pressure is high. Accordingly, a method suitable for applying compressive pressure is to apply compressive pressure to the cell structure 14 within the can 11 and hold the cell structure 14 therein, without allowing relative positional shifting between the mat and can, as much as possible. From this perspective, with the wrapping method, swaging method, and the roll forging method, the can 11 has surrounded the cell structure 14 wrapped with the compressed resilient material 15 before applying compressive pressure, so there is little relative positional shifting between the can 11 and the compressed resilient material 15, a desirable factor. With the clamshell method, positional shifting between the can halves 11a and 11b and the compressed resilient material 15 can be suppressed to a certain extent by making improvements in the method of securing the can wherein the cell structure 14 is sandwiched between the upper and lower split container (can) halves 11a and 11b by bending the can halves 11a and 11b, but this would necessitate the canning device and jigs becoming more complex. The pressing method can be employed as a method wherein the cell structure 14 is positioned within the can 11, using the swaging method or roll forming method for the means for applying compressive pressure.

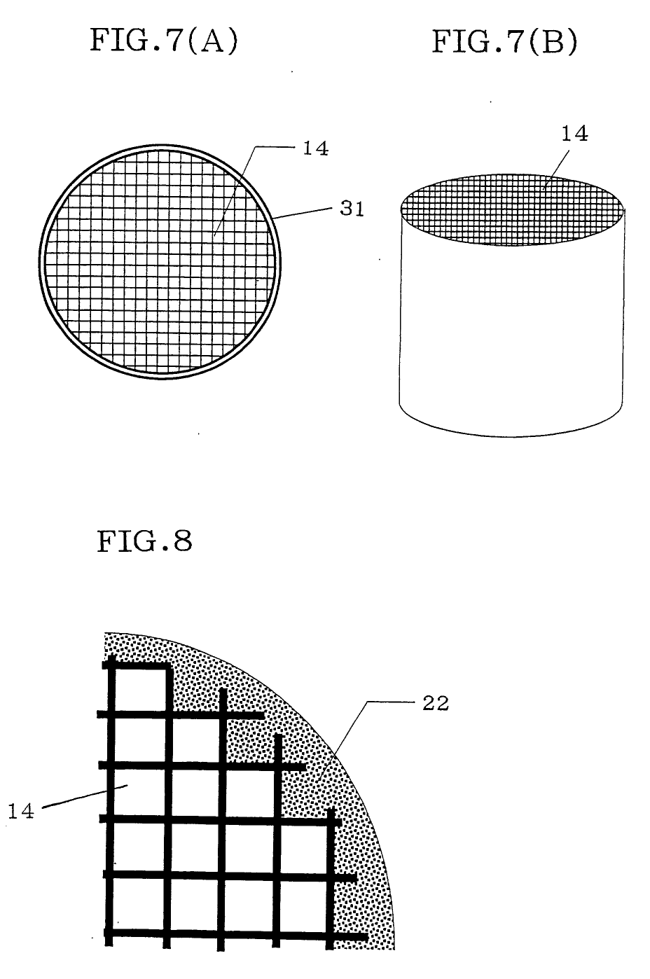

With regard to the non-uniformity of the above problem (3), the cell structure is generally a cordierite ceramic honeycomb structure which has been integrally formed by extrusion and baking, and the precision of the outer diameter changes due to deformations in the process from forming to baking, so this problem involves deformation which is much greater than that of the can. In the event that the gap is not uniform, and the thickness of the compressed resilient material such as the mat placed around the cell structure is constant, this means that the amount of compression of the mat differs between parts where the gap is small and where the gap is large, and the compressive pressure changes accordingly. Accordingly, with the present invention, the periphery portion of the cell structure 14 is preferably worked following forming and baking as shown in FIGS. 7A and 7B so as to yield the cell structure 30 shown in FIG. 7B, thereby improving the precision of the outer diameter of the cell structure, and further forming an outer wall 31 by applying a coating having heat resistance to the worked outer periphery portion. Thus, the outer diameter precision of the cell structure can be improved, and this can be applied to honeycomb structures used for large-size diesel vehicles exhaust gas purification catalyst carriers or diesel particulate filters (DPF) for trucks, buses, etc., as these have relatively great outer diameter dimensions and outer diameter deformation is greater.

Also, the above problem (3) can be solved by improving the outer diameter precision of the cell structure, but can also be solved by optimizing the mat thickness to the gap dimensions. Since it is unrealistic to match the mat thickness to the gap, according to an embodiment of the present invention, instead of using a mat, a compressed resilient material is filled in the gap between the can and the cell structure instead of the mat. Thus, the thickness of the compressed resilient material can be made to match the gap dimensions.

With the swaging method, in addition to the method wherein the compressed resilient material 15 is filled in the gap between the metal container 11 and cell structure 14, as in FIG. 4, a method may be used wherein following applying the compressed resilient material 15 to the outer circumference plane of the carrier 14 which is the cell structure, and following pressing the carrier 14 into the metal container 11 in a state that compressive pressure is essentially not placed upon the carrier outer periphery portion, the metal container 11 is pressurized using a tap 12. Further, a method may be used wherein the cell structure is positioned within a cylindrical mold, and the gap between the mold and the cell structure is filled. With any of these methods, performing thermal processing following coating or filling of the compressed resilient material causes the water or organic binder to evaporate or be decomposed, following which compressive pressure is applied to perform canning.

In the same manner, as shown in FIG. 5, a method may be used wherein the carrier 14 is positioned within the metal container 11 in a state wherein compressive pressure is essentially not applied, following which the metal container 11 is rotated while reducing the outer periphery portion surface of the metal container 11 using a working jig 18 by plasticity working, i.e., the roll forging method, thereby providing compressive pressure. The swaging method and roll forging method are both application examples of plasticity working which is conventionally known. From the above, the wrapping method, swaging method, or roll forging method are more preferable for preventing shifting of the compressed resilient material and manifesting more uniform compression compressive pressure characteristics.

The compressed resilient material used with the present invention is preferably a non-intumescent material essentially not containing vermiculite or a heat expansion material containing small amounts of vermiculite. Also, this compressed resilient material preferably has as the primary component thereof ceramic fiber comprising at least one or a compound of a plurality of materials selected from the following group: alumina, high alumina, mullite, silicon carbide, silicon nitride, zirconia, and titania. A small amount of inorganic binder is added to this, 2 to 20 parts of binder to 100 parts of fiber material by dry weight ratio, and further an appropriate amount of water is added and the pH thereof is adjusted, thus providing the material with flexibility and viscosity suitable for coating or filling. As for the fiber material, flexible ceramic long fibers with fiber diameters between around 2 to 6 μm is suitable for obtaining compression resilience. However, mixing in fibers with greater diameter into the fine fibers enables withstanding the compressive pressure, which can provide an advantage in that breaking of fine fibers with flexibility is suppressed while maintaining flexibility.

As for the fiber material, alumina silicate can be used instead of the above-described, but the essential glass nature means that there is heat shrinkage at high-temperature environments, and crystalline fibers are preferable with regard to this point. In the case of glass material, crystalline components may precipitate within the fibers, leading to deterioration of the material under high-temperature environments. Accordingly, care must be taken regarding high-temperature heating characteristics for glass material.

It is conventionally known that examples of inorganic binders that are usable include water-glass, colloidal silica, colloidal alumina, and so forth. In order to obtain further heat-resistant stability and low-expansion characteristics, ceramic powders such as cordierite, silicon nitride, SiC, etc., may be used. Organic binders can be used as well as inorganic binders, from the perspective of binding. It is conventionally known that using organic binders such as emulsion latex and the like can exhibit advantages of suppressing shifting of the mat at the time of canning, in addition to binding. Whether there essentially is compressed resilience or not is determined from the characteristics of the ceramic fiber included (whether flexible or not) and the ratio of the fiber to the binder. As can be understood from the conventional art, the bulk density of the compressed resilient material containing ceramic fibers is preferably 0.05 to 0.3 g/cm³ in an uncompressed state, and the greater the ratio of the fiber becomes, the higher the compression resilience capabilities are, and the lower the ratio of the fiber becomes, the lower the compression resilience capabilities are. The amount of vermiculite contained therein should be small, preferably within 15% by weight, in order to suppress the heat expansions characteristics as much as possible to reduce change in compressive pressure. However, in the event that the usage temperature exceeds 800° C., addition of small amounts of vermiculite becomes fairly meaningless, and thus is undesirable. Cushioning characteristics can be increased by mixing appropriate amounts of heat-resistant metal fibers in, formed of such as stainless steels, nickels, tungsten, molybdenum, and so forth. In the event that the material is to be exposed to high-temperature exhaust gasses, fiber erosion occurs, so erosion endurance can be improved by the metal fibers.

Also, according to the present invention, high cushioning characteristics can be obtained by coating non-compression resilient, i.e., an essentially non-cushioning, heat-resistant and low-expansion material on the outer periphery portion of the cell structure, and further coating a heat-resistant and low-expansion compressed resilience material having cushioning characteristics containing ceramic fibers or ceramic fibers and heat-resistant metal fibers thereupon, or sequentially layering ceramic fibers or ceramic fibers and heat-resistant metal fibers toward the outside of the non-compression resilient layer in the form of fiber sheets, or like methods, thereby sequentially increasing the amount to yield a layered placement (inclined structure).

According to the present invention, as shown in FIG. 7A, applying a non-compression resilient material to the outer periphery portion of the carrier 14 to form an outer wall 31 allows the precision of the outer diameter to the cell structure to be suitable, and change in the gap between the metal container (casing) and the cell structure can be reduced, thereby reducing change in the compressive pressure acting on the carrier at the time of canning. Also, compressive pressure change can be reduced so the compressive pressure can be set to a low value, enabling canning of cell structures with relatively low strength. Whether there essentially is compressed resilience or not is determined from the characteristics of the ceramic fiber included (whether flexible or not) and the ratio of the fiber to the binder, so a non-compression resilient material can be obtained by either using fibers with low flexibility, or reducing the ratio of fibers. As can be understood from the conventional art (Japanese Patent No. 2,613,729), and binding characteristics and an appropriate viscosity can be obtained by using ceramic fibers and ceramic particles as a skeleton material therefor and adding inorganic binder and water thereto, thereby obtaining a non-compression resilient material which can be coated onto the article.

Also, according to the present invention, as shown in FIG. 6, compressed resilient material 15 and heat resistant metal wire mesh 20 are used in a mixed state (i.e., a mixed material), and the mixed material is introduced between the cell structure 14 and the inner face of the metal container 11 while providing compressive pressure to the cell structure 14, thereby enabling the cushioning characteristics of the compressed resilient material to be improved, using the spring characteristics of the wire mesh. Preferably employed is a method wherein the wire mesh is positioned around the cell structure beforehand and the compressed resilient material is filled in from around the overall cell structure, or a method wherein the cell structure and the wire mesh are placed within the metal container such that the wire mesh is introduced between the structure and the metal container, following which the compressed resilient material is filled in between the metal container and the structure.

A compressed resilient holding structure comprising primarily metal wire mesh has been conventionally known, but there have been problems of the holding force thereof deteriorating due to the resilience capabilities of the metal material being lost from high exhaust gas temperatures and the wire mesh loosing its springiness, and accordingly holding structures primarily using expansion mats have come to be mainstream.

However, as described above, recently, the articles have come to be exposed to even higher exhaust gas temperature environments and the need has arisen to avoid sudden compressive pressure changes, so non-heat expanding mats have come into use. These non-heat expanding mats are advantageous in that the compressive pressure changes from temperature change are small, but the compression resilience capabilities are relatively small, and the cushioning characteristics may be lower than those of heat expanding mats containing vermiculite and metal wire mesh, if temperature priorities are ignored.

Accordingly, it has been found to combine non-intumescent holding materials with metal wire mesh in order to supplement the low cushioning characteristics of the non-intumescent holding materials. That is to say, as described above, including wire mesh within the layer of the non-intumescent material suppresses increase in temperature of the wire mesh by the non-intumescent holding material absorbing the heat transmitted or radiated from the cell structure heated by the exhaust gasses, thus preventing the wire mesh from loosing its springiness. Also, increasing the cushioning characteristics allows the amount of compression necessary for obtaining the required compressive pressure to be reduced, thus allowing the thickness of the compression expansion holding material layer to be reduced, thereby reducing the gap between the metal container and the cell structure. Hence, the effective cross-sectional area of the cell structure for passage of exhaust gas can be increased, thereby reducing pressure loss.

Also, with the present invention, as shown in FIG. 8, the outer periphery portion of the honeycomb structure 14 which is the cell structure is worked to remove low-strength portions where cell deformations exist, following which a non-compression resilient, heat-resistant, and low-heat-expansion material is coated on the outer periphery portion of the structure, so as to form a periphery portion coating portion 22, thereby strengthening the periphery portion of the honeycomb structure (carrier) and improving the isostatic strength. Further, the periphery portion coating portion 22 can be formed by methods such as coating a heat-resistant and low-expansion compressed resilience material having cushioning characteristics containing ceramic fibers or ceramic fibers and heat-resistant metal fibers around the non-compression resilient material, or sequentially layering ceramic fibers or ceramic fibers and heat-resistant metal fibers toward the outside of the non-compression resilient layer in the form of fiber sheets, or like methods, thereby sequentially increasing the amount to yield a layered placement (inclined structure), and consequently obtaining high cushioning characteristics. Thus, the outer diameter precision of the honeycomb structure is improved by working and coating the periphery portion thereof, and the gap between the honeycomb structure and the metal container can be reduced which reduces the compressive pressure, so great increases or decreases the compressive pressure can be avoided.

Now, working the periphery portion of the honeycomb structure removes the outer wall, which causes the cell partitions to be exposed, and the periphery plane of the structure becomes rough due to these partitions. The no-compression resilient material should be coated so as to fill in between the cell partitions and fill in the roughness. In the event that heat expanding material exists between cell partitions, the partitions will be pressed and broken when heated due to the expanding, so non-heat-expanding materials must be used for a honeycomb structure while has lost the outer wall due to periphery portion working.

Enabling the canning compressive pressure to be set lower by coating the periphery portion of the ceramic honeycomb structure so as to strengthen the periphery portion of the structure and also improve the precision of the outer diameter of the carrier means that not only is non-heat expanding material applicable as the compressed resilient material, but also heat expanding material containing vermiculite can be applied as well. However, the amount of vermiculite should be kept as small as possible, in order to avoid sudden increase in compressive pressure due to heat expansion. Also, an arrangement may be made wherein the non-heat expanding compressed resilient material is directly fill and applied to the periphery portion of the structure of which the periphery portion has been worked. Excellent outer diameter precision of the structure enabling setting the gap between the metal container and the structure means that the effective cross-sectional area of the honeycomb structure for passage of exhaust gas can be increased, thereby furthering reduction of pressure loss.

Also, a method may be employed wherein the cell structure is held in the metal container before being caused to carry the catalyst, and then later carrying the catalyst. According to this method, nicking or damaging of cell structures during the process of carrying the catalyst can be avoided.

As for the cell structure used with the present invention, the cell structure may be a foam structure formed of a ceramic material or a heat-resistant metal material, instead of the honeycomb structure. In the case of a foam structure, welding to the metal container may be difficult even if the structure is formed of a metal. The material of the cell structure may be one or a compound of a plurality of materials selected from the following group of heat-resistant materials: cordierite, alumina, mullite, zirconia, zirconium phosphate, aluminum titanate, silicon carbide, silicone nitride, titania, stainless steel materials, nickel materials, and the like, which is effective for structurally weak structures with thin cell partitions.

Now, the cell shape of the honeycomb structure formed by extrusion may be triangular, quadrangular, hexagonal, or round, as shown in FIG. 10, and generally a square shape which is a type of quadrangular shape is used, but recently use of hexagonal shapes becoming more commonplace, as well. Table 1 shows examples of types of cell structures.

TABLE 1

| | Cell | | | |
|---|---|---|---|---|
| Cell | partition | | | |
| structure | thickness | Cell pitch | | Percentage |
| (nominal) | (at center) | (at center) | | of opening |
| mil/cpsi | mm | mm | Cell form | % |
| 3.5/600 | 0.090 | 1.114 | Hexagon cell | 85.0 |
| 3.5/400 | 0.090 | 1.270 | Square cell | 86.3 |
| 3.5/400 | 0.090 | 1.365 | Hexagon cell | 87.2 |
| 3.0/600 | 0.075 | 1.037 | square cell | 85.7 |
| 3.0/400 | 0.075 | 1.270 | Same as above | 88.4 |
| 2.5/1500 | 0.065 | 0.656 | Same as above | 85.3 |
| 2.0/1200 | 0.050 | 0.733 | Same as above | 86.8 |
| 2.5/900 | 0.065 | 0.847 | Same as above | 85.3 |
| 2.5/900 | 0.065 | 0.910 | Hexagon cell | 86.3 |
| 2.5/800 | 0.065 | 0.898 | Square cell | 86.1 |
| 2.5/600 | 0.065 | 1.037 | Same as above | 87.9 |
| 2.5/600 | 0.065 | 1.114 | Hexagon cell | 88.7 |
| 2.5/600 | 0.065 | 1.576 | Triangle cell | 86.3 |
| 2.0/900 | 0.050 | 0.847 | Square cell | 88.5 |
| 2.0/900 | 0.050 | 1.287 | Triangle cell | 86.9 |
| 2.0/800 | 0.050 | 0.898 | Square cell | 89.1 |
| 2.0/800 | 0.050 | 1.365 | Triangle cell | 87.6 |
| 2.0/600 | 0.050 | 1.037 | Square cell | 90.5 |
| 2.0/600 | 0.050 | 1.576 | Triangle cell | 89.3 |
| 1.5/3000 | 0.035 | 0.464 | Square cell | 85.6 |
| 1.5/3000 | 0.035 | 0.705 | Triangle cell | 83.6 |
| 1.5/1800 | 0.035 | 0.599 | Square cell | 88.7 |
| 1.5/1500 | 0.035 | 0.656 | Same as above | 89.7 |
| 1.5/1200 | 0.035 | 0.733 | Same as above | 90.7 |
| 1.5/900 | 0.035 | 0.847 | Same as above | 91.9 |
| 1.5/900 | 0.035 | 1.287 | Triangle cell | 90.9 |
| 1.5/800 | 0.035 | 0.898 | Square cell | 92.4 |
| 1.5/600 | 0.035 | 1.037 | Same as above | 93.4 |
| 1.5/600 | 0.035 | 1.576 | Triangle cell | 92.5 |

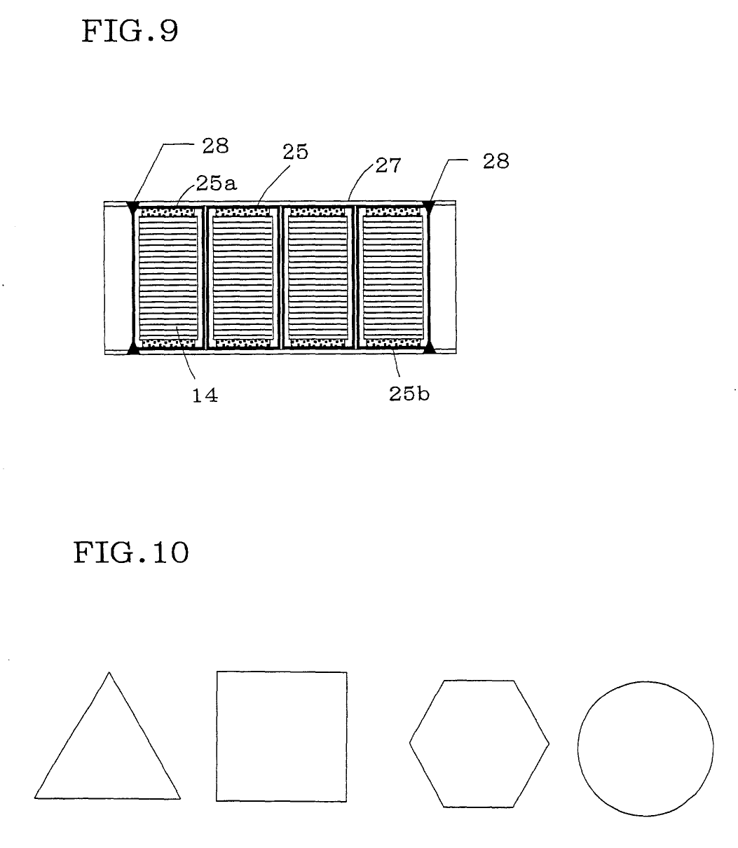

Further, as shown in FIG. 9, according to the present invention, a cell structure mounting container and an assembly thereof is provided, the assembly comprising cell structure mounting containers 25 holding cell structures 14 and arrayed serially within a single metal sleeve 27, which forms a catalytic converter wherein there is little change in compressive pressure on the cell structure within the metal container of the cell structure mounting container under the usage temperature range, and the compressive pressure distribution thereof is made to be uniform so as to prevent damage to the cell structure. At least the cell structure mounting container 25a positioned at the front side and the cell structure mounting container 25b positioned at the rear side of the metal sleeve 27 among the series of cell structure mounting containers 25 are fixed to the metal sleeve 27 by laser beam welding at predetermined positions 28 of the outer periphery portion of the metal sleeve 27.

Laser beam welding is capable of focusing energy on a local spot, so effects of heat to the areas surrounding the welding potion can be suppressed, thereby avoiding heat damage to the compressed resilient material.

Specific embodiments of the present invention will now be described.

### FIRST THROUGH FOURTH EMBODIMENTS

### FIRST COMPARATIVE EXAMPLE

The compressive pressure and structure endurance at the time of canning were measured.

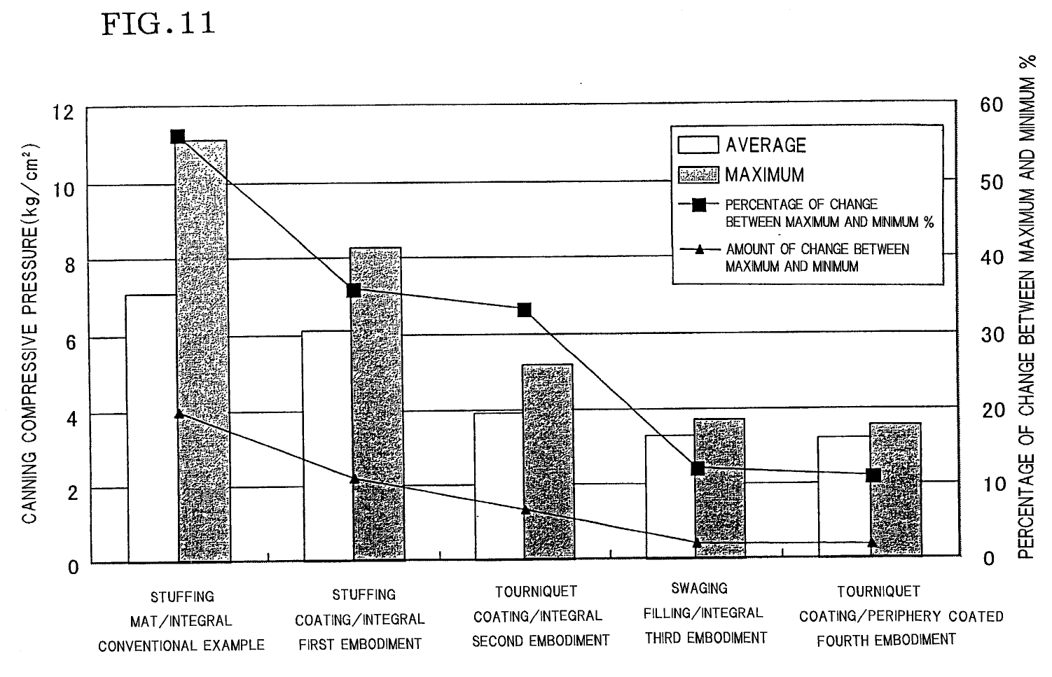

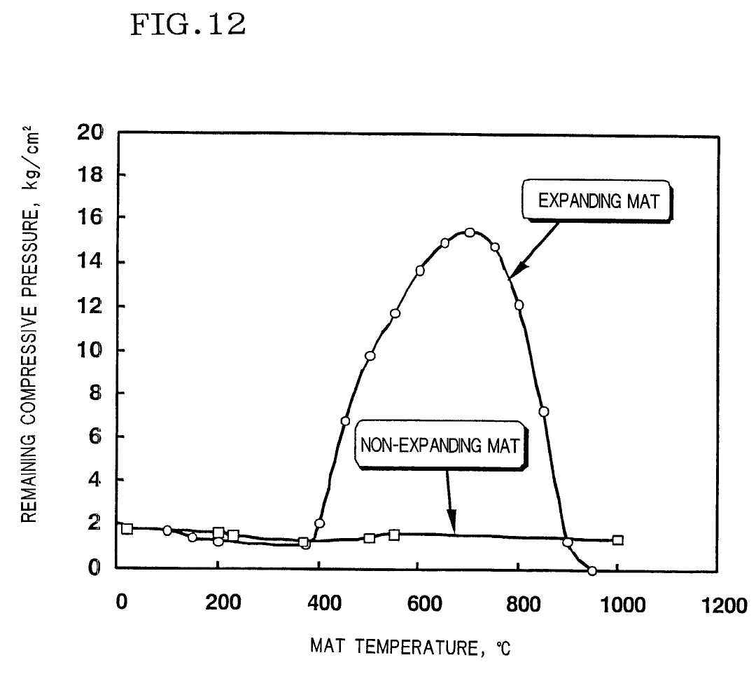

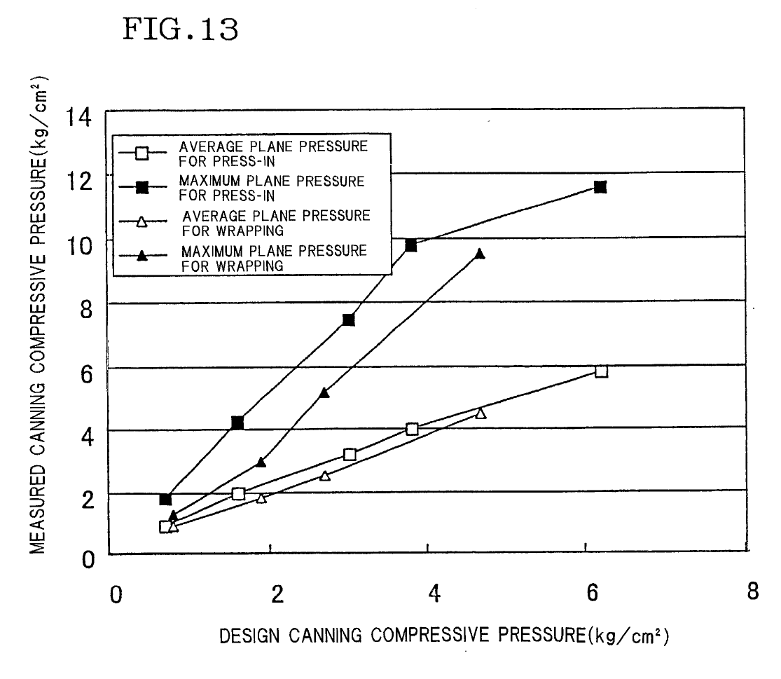

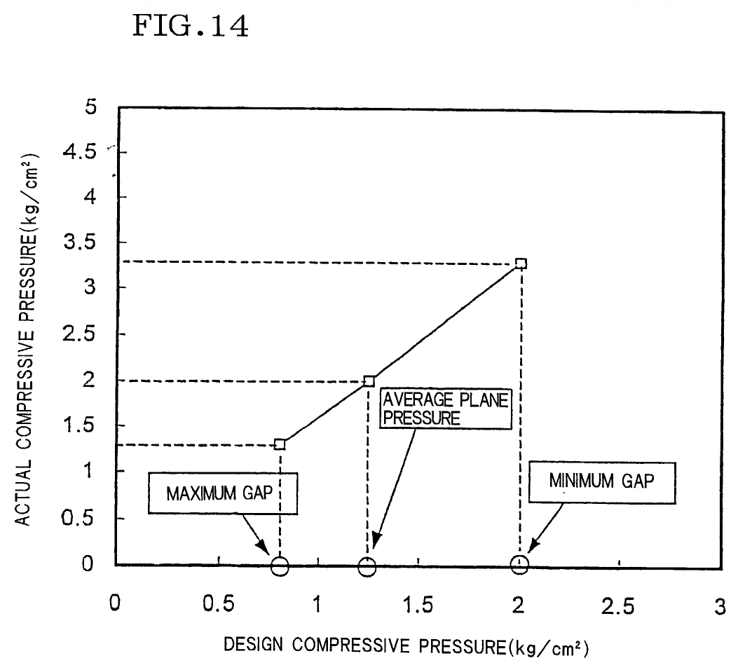

Table 2 and FIG. 11 shown the results of comparing canning by the conventional method (First comparative example) and canning according to the present invention (First through Fourth embodiments) under the same design conditions of canning design compressive pressure of 3 kg/cm², and the compressed resilient material and cell structure shown in Table 2.

Before carrying out the canning, the honeycomb structures were all subjected to screening at pressure of 10 kg/cm² or 5 kg/cm² using an isostatic testing device, and only the products without abnormalities were used for the canning test.

With regard the third and fourth embodiments of the present invention, the same tests were performed for the other honeycomb structures which are the cell structures, and no cell structure damage was observed in any of these. Particularly, with the third and fourth embodiments of the present invention, the design compressive pressure and the actual canning compressive pressure were almost the same, showing that canning according to design could be realized. Also, for the low-isostatic strength honeycomb structures, canning can be performed without any damage problems by setting the design compressive pressure lower accordingly.

TABLE 2

| | Compression material | Cell structure | Canning | Canning test results |
|---|---|---|---|---|
| Comparative Example 1 | Alumina fiber type non- | Honeycomb structure formed by integral | Press-in | Some honeycomb |
| | intumescent mat | extrusion with cordierite outer wall | | structure s destroyed |
| | | Dimensions: 106 diameter × 150 | | at mat mating face. |
| | | Cell structure: 2.5 mil/900 cpsi | | |
| | | Iso-strength: 10 kg/cm2 Screening | | |
| First embodiment | Application of | Same as above | Same as | No damage to |
| | compression material | | above | honeycomb |
| | containing alumina fiber | | | structure |
| Second embodiment | Same as above | Same as above | Wrapping | Same as above |
| Third embodiment | Filling with compression | Honeycomb structure formed by integral | Swaging | Same as above |
| | material containing | extrusion with cordierite outer wall | | |
| | alumina fiber | Dimensions: Same as above | | |
| | | Cell structure: 1.5 mil/900 cpsi | | |
| | | Iso-strength: 5 kg/cm2 Screening | | |
| Fourth embodiment | Applying compression | Structure coated on periphery portion | Swaging | Same as above |
| | material containing | following extrusion forming of | | |
| | alumina fiber | cordierite | | |
| | | Dimensions: Same as above | | |
| | | Cell structure: Same as above | | |
| | | Iso-strength: Same as above | | |

Note: Iso-strength stands for isostatic strength.

### FIFTH AND SIXTH EMBODIMENTS

### SECOND COMPARATIVE EXAMPLE

Next, punching and heating/cooling vibration testing was performed.

For the second comparative example which is the conventional example, water was added to a mixture of alumina fiber 45% (dry mass percentage), inorganic binder 15%, and vermiculite 40%, and kneaded. The resulting heat expansion material was coated to the periphery portion of the honeycomb structure, dried, and canned by wrapping. This was used as a sample for the punching test. An electric furnace was attached to the testing device, the canned sample was set into a jig in the electric furnace, and while maintaining a predetermined temperature, the lead for punching the honeycomb structure with a silica rod was measured. A punching load of 5 kgf or higher is judged to be suitable. Prior to the punching test, the sample was subjected to 100 cycles of heating/cooling in a propane gas burner testing device, with each cycle consisting of 10 minutes at 950° C. and 10 minutes at 100° C. The canning samples according to the present invention (fifth and sixth embodiments) were tested in the same manner and compared, the results of which are shown in Table 3. Heating/cooling vibration testing was also performed wherein vibrations are applied under a constant condition of 200 Hz while undergoing 10 cycles of heating/cooling with each cycle consisting of 5 minutes at 900° C. and 5 minutes at 100° C. Whether or not the positional shifting of the honeycomb structure (106 mm in diameter×150 mm) within the metal container following the testing was within the tolerance range was used for judging whether the samples passed the test.

TABLE 3

| | Compression | | | Punching test results | | |
|---|---|---|---|---|---|---|
| | material | Cell structure | Canning | temperature | 950° C. | Evaluation |
| Comparative | Coating heat | Honeycomb structure formed by | Tornqiuet | Defect | Defect | Unacceptable |
| example 2 | expansion material | integral extrusion with cordierite | | | (load 0) | |
| | (including much | outer wall | | | | |
| | vermiculite) | Dimensions: 55 diameter × 45 | | | | |
| | | Cell structure: 4.5 mil/600 cpsi | | | | |
| Fifth | Filled with non- | Honeycomb structure formed by | Swaging | Good | Good | Passed |
| embodiment | intumescent | integral extrusion with cordierite | | | | |
| | material containing | outer wall | | | | |
| | alumina | Dimensions: 55 diameter × 45 | | | | |
| | | Cell structure: 2.5 mil/900 cpsi | | | | |
| Sixth | Same as above | Structure coated on periphery | Same as above | Good | Good | Passed |
| embodiment | | portion following extrusion forming | | | | |
| | | of cordierite | | | | |
| | | Dimensions: Same as above | | | | |
| | | Cell structure: 2.0 mil/900 cpsi | | | | |

| | | Heating/cooling vibration test results | | |
|---|---|---|---|---|
| Temperature | Vibration | Comparative | Fifth | Sixth |
| conditions | acceleration | example 2 | embodiment | embodiment |
| 10 cycles of 5 | 20G | Good | Good | Good |
| minutes at 900° C. | 30G | Good | Good | Good |
| and 5 minutes at | 40G | Defect | Good | Good |
| 100° C. | | | | |

| | | | |
|---|---|---|---|
| Evaluation | Unacceptable | Passed | Passed |

As can be understood from the above description, according to the present invention, a cell structure mounting container and an assembly thereof, capable of preventing shifting of the compressed resilient material and holding the cell structure within the metal container while maintaining more uniform compressive pressure characteristics, can be provided.

What is claimed is:

1. A cell structure mounting container mounting a cell structure within a metal container;
wherein said cell structure is held within said metal container by providing a compressed resilient material having heat-resistance and cushioning characteristic between the periphery portion of said cell structure and said metal container, in a compressed state;
and wherein said compressed resilient material having heat-resistance and cushioning characteristics is a heat-resistant low thermal expansion material containing either ceramic fiber or ceramic fiber and heat-resistant metal fiber, having compression characteristic which is substantially free from a significant increase or decrease in a practical use temperature range, with the compression force acting upon the periphery portion of said cell structure not changing greatly, and further acting essentially uniformly upon the entire outer periphery portion of said cell structure.

2. A cell structure mounting container according to claim 1, wherein said compressed resilient material is provided between the periphery portion of said cell structure and said metal container in a state of not having a mating face.

3. A cell A cell structure mounting container according to claim 1, which is used for purification automobile exhaust gasses.

4. A cell structure mounting container according to claim 1, wherein said compressed resilient material having heat-resistance and cushioning characteristics is a non-intumescent material essentially not containing vermiculite or non-intumescent material containing small amounts of vermiculite, with the primary component thereof being ceramic fiber comprising at least one or a compound of a plurality of materials selected from the following group: alumina, high alumina, mullite, silicon carbide, silicon nitride, zirconia, and titania.

5. A cell structure mounting container according to claim 1, wherein said compressed resilient material is covered on the outer periphery portion of said cell structure beforehand, following which said cell structure is stored within said metal container, and compressive pressure is applied to said cell structure, thereby holding said cell structure within said metal container.

6. A cell structure mounting container according to claim 1, wherein the means for mounting said cell structure within said metal container and applying compressive pressure to said cell structure via said compressed resilient material is one of clamshell, stuffing, torniquet, swaging, or roll or rotary forging.

7. A cell structure mounting container according to claim 6, wherein, following positioning said cell structure within the space in said metal container, the gap between said metal container and said cell structure is filled with said compressed resilient material, and applying external pressure from the outer side of said metal container holds said cell structure within said metal container.

8. A cell structure mounting container according to claim 5, wherein the means for applying compressive pressure to said cell structure via said compressed resilient material is either swaging or roll forging.

9. A cell structure mounting container according to the claim 1, wherein said compressed resilient material is filled in the state of said cell structure at a low temperature being positioned within said metal container at a high temperature, following which the entire article is cooled to room temperature, thereby applying compressive pressure to said cell structure.

10. A cell structure mounting container according claim 1, wherein said compressed resilient material and heat-resistant metal wire mesh are, in a mixed state, introduced between said cell structure and said metal container while applying compressive pressure to said cell structure.

11. A cell structure mounting container according to claim 10, wherein said wire mesh is positioned on the periphery portion of said cell structure beforehand, and said compressed resilient material is applied from the periphery portion so as to fill in the wire mesh entirely.

12. A cell structure mounting container according to claim 10, wherein said cell structure and said wire mesh are placed within said metal container beforehand such that said wire mesh is introduced between said metal container and said cell structure, and said compressed resilient material is filled in between said metal container and said cell structure.

13. A cell structure mounting container according to any claim 1, wherein said cell structure is a ceramic honeycomb structure having a plurality of cell channels formed of a plurality of partitions, wherein the cell partitions are 0.1 mm or less in thickness, and the percentage of opening is 85% or more.

14. A cell structure mounting container according to claim 13, further comprising an outer wall forming an outer circumference outline for said cell structure at the periphery portion of said ceramic honeycomb structure, wherein the thickness of said outer wall is at least 0.05 mm.

15. A cell structure mounting container according to claim 14, wherein the periphery plane of said cell structure outer wall is covered with a heat-resistant low thermal expansion material which essentially does not have compression resilience.

16. A cell structure mounting container according to claim 13, wherein said ceramic honeycomb structure comprises
a main unit which does not have an outer wall and has the cell partitions exposed to the outer periphery portion of said ceramic honeycomb structure; and
a shell part of heat-resistant material containing ceramic fiber positioned at the periphery portion of said main unit so as to also exist between exposed cell partitions.

17. A cell structure mounting container according to claim 16, wherein a heat-resistant material layer containing said ceramic fiber at said shell portion has compression resilience, thereby manifesting compressive pressure for holding said honeycomb structure within said metal container.

18. A cell structure mounting container according to claim 12, wherein said cell structure is a foam structure formed of a ceramic material or a heat-resistant metal material.

19. A cell structure mounting container according to claim 18, wherein said cell structure comprises one or a compound of a plurality of materials selected from the following group of heat-resistant materials: cordierite, alumina, mullite, zirconia, zirconium phosphate, aluminum titanate, silicon carbide, silicone nitride, titania, stainless steel materials, nickel materials, and the like.

20. A cell structure mounting container according to claim 19, wherein, following causing said cell structure to carry a catalyst component, said cell structure is stored in and held within said metal container.

21. A cell structure mounting container according to claim 19, wherein, following mounting a nd holding said cell structure in and by said metal container, a catalyst component is held by said cell structure.

22. A cell structure mounting container assembly, comprising a plurality of cell structure mounting containers mounting a cell structure within a metal container;
wherein said cell structure is held within said metal container by providing a compressed resilient material having heat-resistance and cushioning characteristic between the periphery portion of said cell structure and said metal container, in a compressed state;
and wherein said compressed resilient material having heat-resistance and cushioning characteristics is a heat-resistant low thermal expansion material containing either ceramic fiber or ceramic fiber and heat-resistant metal fiber, having compression characteristic which is substantially free from a significant increase or decrease in a practical use temperature range, with the compression force acting upon the periphery portion of said cell structure not changing greatly, and further acting essentially uniformly upon the entire outer periphery portion of said cell structure
mounting said cell structure and arrayed serially along the direction of fluid flow within a single metal outer cylinder, wherein, of said plurality of cell structure mounting containers, at least the cell structure mounting containers at the front side and the rear side are fixed to said metal outer cylinder by laser beam welding from the outer periphery portion of said metal outer cylinder.
